(19) United States
(12) Patent Application Publication
(10) Pub. No.: US 2005/0203881 A1
(43) Pub. Date: Sep. 15, 2005

(54) Database user behavior monitor system and method

(76) Inventors: Akio Sakamoto, Cupertino, CA (US); Chung-Kuang Chou, Sunnyvale, CA (US); Wani G. Tang, Saratoga, CA (US); Jianguo Hu, Santa Clara, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 10/796,932

(22) Filed: Mar. 9, 2004

(51) Int. Cl. G06F 17/30

(52) U.S. Cl. 707/3

(57) ABSTRACT

Embodiments of the present invention provide techniques for monitoring a database system for anomalous activity. User behavior information relative to a subject database being monitored may be automatically collected, analyzed and compared with one or more policies to detect anomalous activity. Embodiments collect user behavior data regarding the subject database from a variety of sources, including an audit trail and dynamic views in cooperation with the database management system of the database. Embodiments employ one or more of statistics-based intrusion detection (SBID) and rule-based intrusion detection (RBID) to detect anomalous database activity. If suspicious database access that deviate from the normal usage pattern are detected, a targeted operation, such as alerting the responsible security officers, generating reports, email alerts or the like, is performed.

### FIELD OF THE INVENTION

The present invention relates to managing database systems. In particular, the present invention relates to a method and apparatus for monitoring a database system.

### BACKGROUND

Protecting data in a networked system is critical. The types of situations that can threaten the security of valuable data are numerous and increasing as network systems evolve. When security breaches occur, it is important to be able to detect them. Otherwise, as is often the case, the data remains vulnerable to similar types of events in the future.

The types of problems network managers face in protecting valuable data include, for example, hack attacks, unauthorized usages, insider fraud or misuse, and intellectual information theft.

Different approaches have been developed for some of the common problems encountered by networked systems. For example, firewalls and virtual private networks guard networked systems against unauthorized access from external sites. Access control through the use of passwords or designation of privileges provides some level of protection. However, firewalls and virtual private networks cannot protect the data from insider theft because passwords could be stolen; privileges are difficult to administer, users can often access data that is outside of the scope of their work, and security can easily be breached.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

Embodiments of the present invention provide techniques for monitoring a database system for anomalous activity. User behavior information relative to a subject database being monitored may be automatically collected, analyzed and compared with a statistically derived norm and/or one or more policies to detect anomalous activity. Embodiments collect user behavior data regarding the subject database from a variety of sources, including audit trails and dynamic views in cooperation with the database management system of the database. Embodiments employ one or more of statistics-based intrusion detection (SBID) and rule-based intrusion detection (RBID) to detect anomalous database activity. In statistics-based intrusion detection, the collected information is analyzed using statistical profiling to determine a normal usage profile. In rule-based intrusion detection, the collected data is compared against explicit security rules. If suspicious database accesses that deviate from the normal usage pattern are detected, a targeted operation, such as alerting the responsible security officers, generating reports, email alerts or the like, is performed.

In one embodiment, a mechanism is provided to determine a normal usage pattern from historical information about database activity. A database access that deviates from the normal usage pattern in a statistically significant way will be detected and alerted. An example of a usage pattern includes database access frequency by hour of day.

In one embodiment, a mechanism is provided to enable users to specify explicit security rules. A database access violating the rules will be detected and alerted. Some examples of security rules include suspicious OS users or locations.

In one embodiment, database access information is collected using facilities provided by the database management system that controls the subject database. For example, database management systems may provide an audit trail, which includes information about database accesses. Database management systems also provide dynamic performance views which provide information on current database usage, such as current user sessions and resource utilization. This information can be used in conjunction with the information obtained from an audit trail.

Embodiments enable monitoring at one or more levels, including database object level monitoring, database user level monitoring and database session level monitoring. Database object level monitoring focuses on a particular database object. Database user level monitoring focuses on a database user. Database session level monitoring focuses on a database login session. Embodiments can support various security policies for each monitoring level based on a variety of intrusion detection approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a high level overview of a network computing system in which techniques for monitoring a database may be implemented in one embodiment.

FIG. 2 is a block diagram that illustrates a high level overview of processes in an example database audit engine in one embodiment.

FIGS. 3A-3E are block flow diagrams that illustrate a high level overview of data collection, analysis and anomaly detection processing in one embodiment.

FIG. 4 is a graph that illustrates an example probability distribution of accesses to a database in one embodiment.

FIG. 5 is a block diagram that illustrates a high level overview of a database monitoring system in one embodiment.

FIGS. 6A-6M are screen shots that illustrate an example of configuring a monitoring operation in one embodiment.

FIG. 7 is a hardware block diagram that illustrates a representative computer system, which may be used to embody one or more components of an embodiment.

### DETAILED DESCRIPTION OF EMBODIMENT(S)

Overview

A method and apparatus for monitoring a database is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

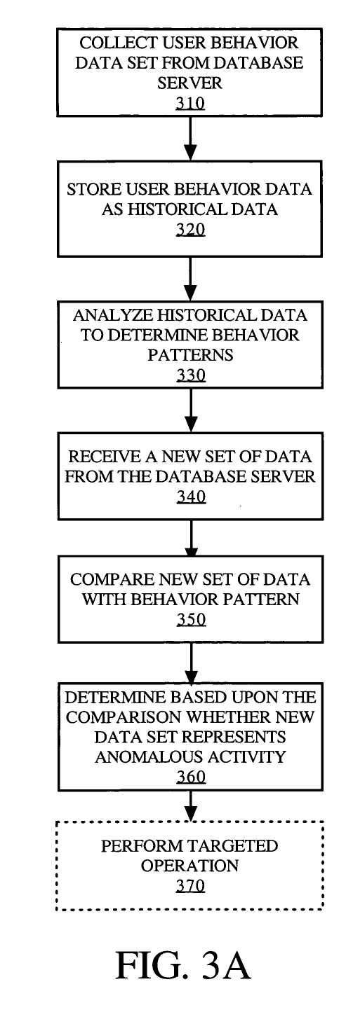

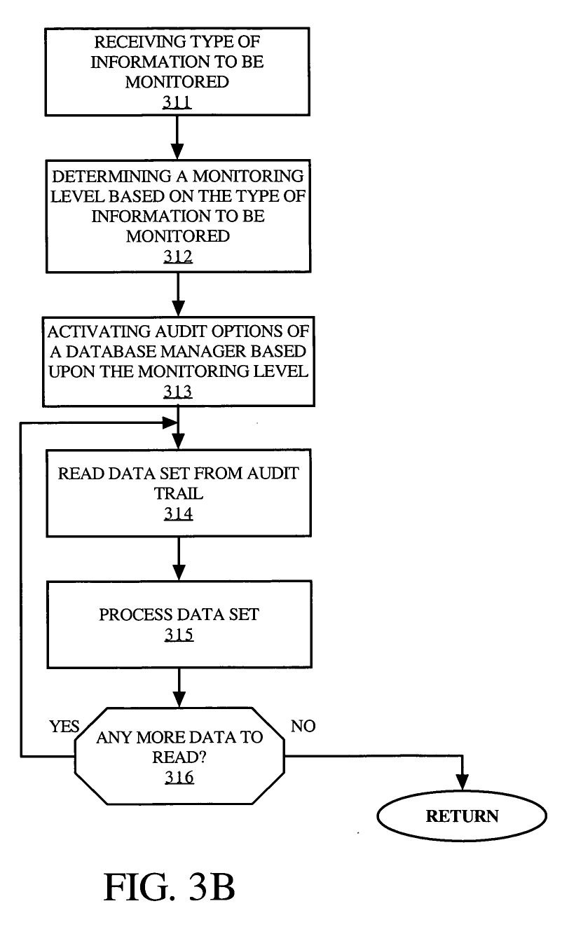

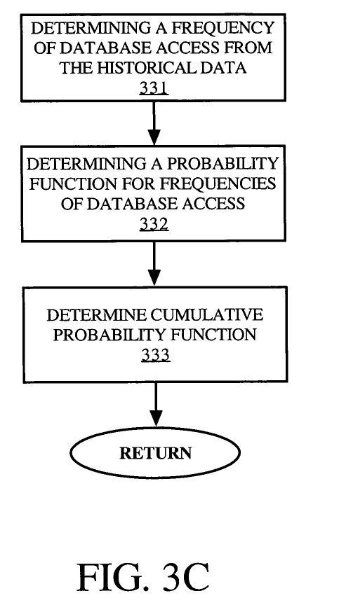

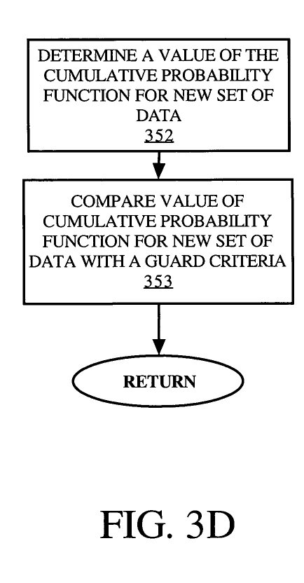

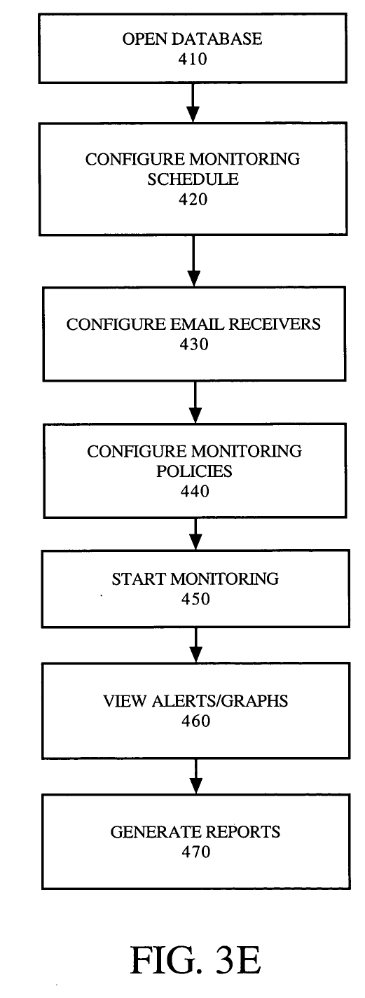

Referring to FIG. 3A, it illustrates a method for monitoring a database according to one embodiment of the invention. The method illustrated in FIG. 3A includes collecting user behavior data that indicates how one or more users use the database. (Block 310) The illustrated method further includes processing and storing the data as historical data. (Block 320) Analyzing the historical data to determine behavior patterns (Block 330) is also part of the illustrated method. The illustrated method further includes receiving a new set of data (Block 340) that indicates how one or more users have used the database. The illustrated method also includes performing a comparison between the new set of data and the behavior pattern. (Block 350) Determining based on the comparison, whether the new set of data satisfies a set of criteria (Block 360) is also part of the illustrated method. The illustrated method also includes determining that the new set of data represents anomalous activity if the new set of data satisfies the set of criteria. (Block 370) Responding to the determination by performing a targeted operation (Block 380) may also be included in the illustrated method.

In one embodiment, collecting user behavior data further includes reading information from an audit trail of the database manager. In one embodiment, collecting user behavior data further includes collecting information at a monitoring level selected from (1) information about database access for one or more selected database objects, (2) information about database access for one or more selected database users and (3) information about database access for one or more selected database user sessions. In one embodiment, collecting user behavior data further includes receiving a type of information to be monitored, determining a monitoring level from the type of information and activating audit options of the database manager based upon the monitoring level determined.

In one embodiment, analyzing the historical data to determine behavior patterns further includes determining a statistical model from the historical data. In one embodiment, determining a statistical model from the historical data further includes determining a frequency of database access from the historical data, determining a probability function for frequencies of database access and determining a cumulative probability function from the probability function. In one embodiment, the probability function may be a Poisson probability distribution, a normal probability distribution or the like.

In one embodiment, performing a comparison between the new set of data and the behavior pattern further includes testing a hypothesis using the new set of data against the statistical model. In one embodiment, testing a hypothesis using the new set of data against the statistical model further includes determining a frequency of database access for the new set of data and determining the threshold value from a guard criteria and a probability function parameter. In one embodiment, testing a hypothesis using the new set of data against the statistical model pattern further includes comparing the frequency of database access for the new set of data with the threshold value.

The historical information may include information about database access for one or more selected database objects. In various embodiments, determining a frequency of database access from the historical data includes one or more of determining a frequency of one or more of object access frequency by hour of day, object access frequency by hour of day and operating system user, object access frequency by hour of day and database user, object access frequency by hour of day and location, object access frequency by hour of day or a combination of at least two of operating system user, database user and location.

The historical information may include information about database access for one or more selected database users. In various embodiments, determining a frequency of database access from the historical data includes one or more of determining a frequency of one or more of user access frequency by hour of day, user access frequency by hour of day and operating system user, user access frequency by hour of day and database user, user access frequency by hour of day and location, user access frequency by hour of day or a combination of at least two of operating system user, database user, and location.

The historical information may include information about database access for one or more selected database user sessions. In various embodiments, determining a frequency of database access from the historical data includes one or more of determining a frequency of one or more of number of page reads per session, access duration per session or number of page reads per unit time.

In various embodiments, performing a targeted operation includes one or more of raising an alert, sending an email, producing a report and performing a visualization.

In one embodiment, determining if the new set of data violates a rule-based policy is performed. If the new set of data violates the rule-based policy, then the new set of data is determined to represent anomalous activity. In one embodiment, anomalous activity comprises suspicious activity.

In other aspects, embodiments of the invention encompass an apparatus and a computer-readable medium configured to carry out the foregoing processes.

Terminology

A “database” includes any data structure used for storing data according to an organization. Databases include relational databases, object databases, hierarchical databases, network databases, multidimensional databases and the like.

“Database triggers” refer to a stored database procedure automatically invoked in response to a specific event involving a database object, such as whenever a table or view is selected or modified.

“Database session” refers to specific connection of a user to a database through a user process. A session lasts from the time the user connects until the time the user disconnects or exits the database application.

“Java Database Connectivity (JDBC) API” is a standard SQL database access interface that allows users to access any data source from the Java programming language.

“Poisson distribution” is the probability distribution of the number of events in the interval when the waiting time between events is exponentially distributed.

“Audit Trail” is a series of records of computer events. It is generated by an auditing system that monitors system activity. The records may be stored in various forms, including, without limitation, a computer file, or database tables.

“Privileges” refers to a set of actions or operations that a user of a network or database is allowed to perform. A privilege may alternatively be referred to as an authorization, or a set of authorizations.

System Description

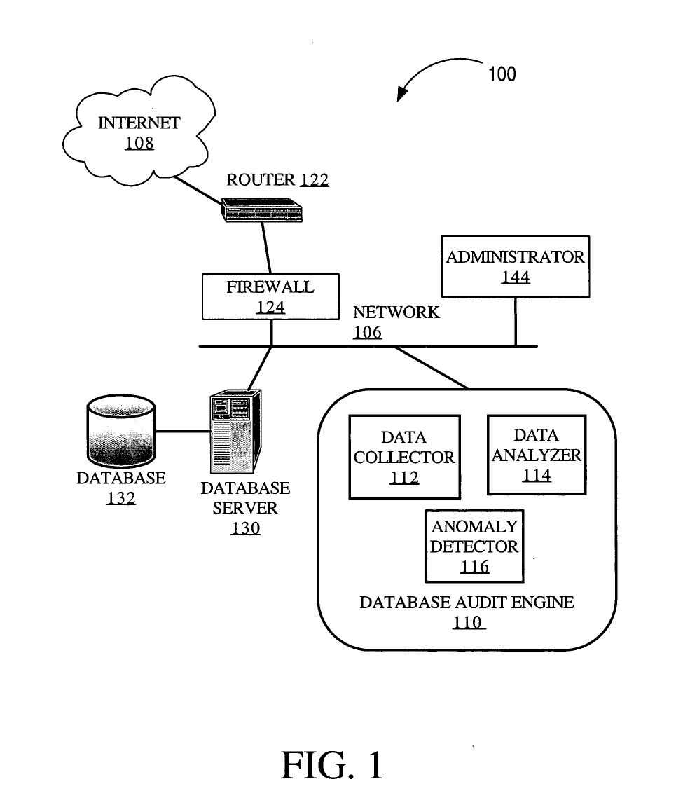

FIG. 1 is a block diagram that illustrates a high level overview of a network computing system in which techniques for monitoring a database may be implemented in one embodiment. According to one embodiment illustrated by FIG. 1, a database audit engine 110 is coupled to a database system comprised of a database server 130 and a database 132 by a network 106 in order to provide monitoring of accesses to the database 132 by users and/or processes. In one embodiment, the network 106 is connected to the Internet 108 through a firewall 124 and a router 122. Firewall 124 is configured to protect the network 106 and associated components from harmful programs sent over the Internet 108. Router 122 manages and controls network traffic between Internet 108 and network 106.

The database server 130 maintains data in the database 132. Some of the data in database 132 may be critical to one or more users on the network 106. The critical data may include, for example and without limitation, audit records, customer account information, and employee salary information. The database 132 may be an integral part of the database server 130 in some embodiments. An administrator station 144 enables an administrator to perform administration functions on the network 106. The administration functions may include monitoring the security of the network 106, including the activities of the users. In some embodiments, other elements and components (not shown in FIG. 1) may be connected with the network 106.

In one embodiment, the database audit engine 110 includes a data collector 112, a data analyzer 114 and an anomaly detector 116. The data collector 112 is configured to read data about user behavior relating to accessing the database 132 from the database server 130 at designated intervals, or upon the occurrence of designated conditions (such as manual commands) and to store the data as historical data. The database analyzer 114 performs analysis operations on the historical data stored by the data collector 112 to determine behavior patterns relating to accessing the database 132. When new data is received, the anomaly detector 116 determines, based upon a comparison of new data with a behavioral pattern determined from historical data, whether the new data represents anomalous activity. Some embodiments provide the ability for the database audit engine 110 to collect, analyze and signal alerts with no noticeable effect on the performance of the database server 130. A more detailed description of an example of processing performed by the data collector 112, the data analyzer 114 and anomaly detector 116 is discussed herein below with reference to FIGS. 3A-3E.

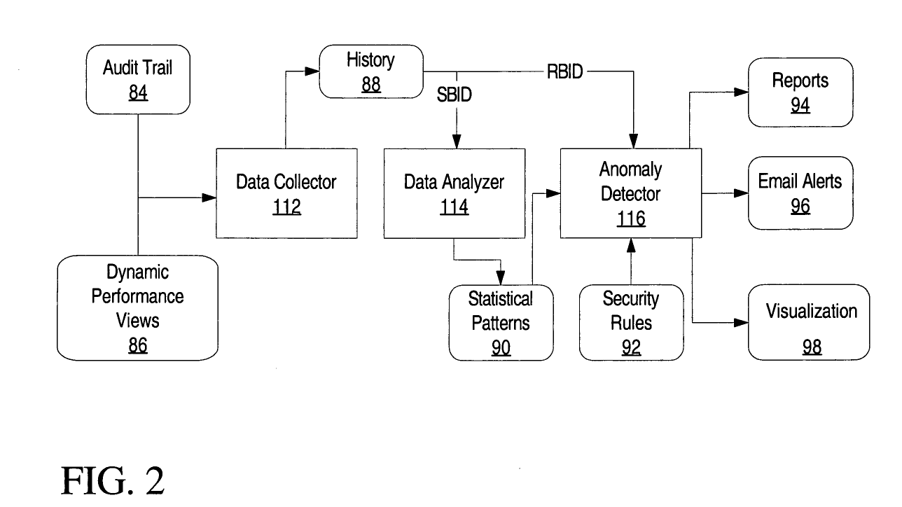

FIG. 2 is a block diagram that illustrates a high level overview of processes in an example database audit engine in one embodiment.

In one embodiment, the database audit engine 110 operates externally to the database server 130 to reduce interference with the database server. In one embodiment, the data collector 112 operates without having to execute agents, for example, on the database server 130. In such embodiments, the data collector 112 gathers information relating to user behavior from audit trail 84 maintained by the database server 130 and/or employs “read-only” access to the database 132 to collect data. In one embodiment, the data collector 112 determines a monitoring level based upon the type of information to be monitored and activates audit options of the database manager 130 based upon this monitoring level. Then, data collector 112 reads audit trail created and maintained by the database server 130 for the configured audit options. In some embodiments, the data collector also obtains dynamic performance views 86 comprising information on database usage, such as user sessions and resource utilization that is maintained by the database management system (DBMS). The data collector 112 stores the user behavior data obtained from the audit trail 84 and dynamic performance views 86 as historical data 88. A more detailed description of an example of processing for collecting user behavior data and storing it as historical data is discussed herein below with reference to FIG. 3B.

The data analyzer 114 executes one or more analysis processes on the historical data 88 stored by the data collector 112. In one embodiment, the data analyzer 114 executes a series of operations including analyzing historical data 88 to determine behavior patterns 90. In one embodiment, data analyzer 114 determines a frequency of database access from historical data 88. The frequency of database access may be computed for a unit of time such as hour of the day or the like. Next, the data analyzer 114 determines a probability function for the frequencies of database access. A more detailed description of an example of processing for analyzing historical data to determine behavior patterns is discussed herein below with reference to FIG. 3C.

When a new set of data is received from the database server 130, the anomaly detector 116 compares this new set of data with the behavior pattern determined from historical data. The anomaly detector 116 determines based upon a comparison of new data with a behavioral pattern determined from historical data 88, whether the new data represents anomalous activity. In one embodiment, anomaly detector 116 also compares the new data with security rules 92 in order to perform rule-based intrusion detection. One or more of the analysis operations may require use of security rules 92 or other rules and conditions designated by an administrator or operator of database server 130. The security rules 92 provide a mechanism for enabling the anomaly detector 116 to determine if a breach of security may have occurred. The administrator station 144 enables management of the security rules 92. Once anomalous data is identified, the anomaly detector 116 performs the targeted operation. For example, the anomaly detector 116 may send e-mail alerts 96 to signal an intrusion to the administrator station 144. The anomaly detector 116 may also or in addition provide reports 94 or create visualizations 98.

In one embodiment, database audit engine 110 detects when an event adversely affects the data maintained by the database server 130. For example, database audit engine 110 may detect unauthorized access and/or manipulation of the data maintained by the database server from an unknown user that accesses the network 106 from over the Internet 108. The database audit engine 110 may also determine when users of the network 106 either intentionally or unintentionally compromise the data stored by the database server 130. The database audit engine 110 may detect the presence of “malware” that is passed through the network 106 when the malware affects the data maintained by the database server 130. Other examples of events that affect the database server 130 and that are detectable by database audit engine 110 include without limitation unauthorized access using a stolen password, insider fraud, misuse, or privilege abuse. An example of insider fraud is copying valuable customer account information by bank tellers. An example of privilege abuse is accessing employee salary information by a database administrator (DBA).

FIG. 3A is a flow diagram that illustrates a high level overview of data collection, analysis and anomaly detection processing in one embodiment. In block 310, data sets comprising user behavior data are collected from the database server. In block 320, user behavior data is stored as historical data. In block 330, the historical data is analyzed to determine behavior patterns. In block 340, a new set the data is received from the database server. In block 350, the new set of data is compared with the behavioral pattern. In block 360, a determination is made based upon the comparison whether the new data set satisfies a set of criteria. In block 370, a determination is made whether the new data represents anomalous activity. In block 380, a targeted operation is performed in the event that anomalous activity has been detected by block 370. Targeted operation may include one or more of sending an email alert, generating a report, performing visualization or the like in various embodiments.

Data Collection

Embodiments of the present invention use one or more of a variety of techniques for collecting information on database access and storing information in an internal database as historical data. The variety of ways to collect information regarding database access from the database management system, includes without limitation, database triggers, database transaction change logs, database audit facilities and database dynamic system views.

Audit facilities may be provided by a variety of commercial database management systems. The audit facilities can be configured to audit various events. The audit facility produces an audit trail that contains database access information. Typically, the database access information tracked by the audit facility is dependent upon the database management system, however, many database management systems provide tracking of audit information such as user name, object name, action, terminal, timestamp and so forth.

A variety of commercially available database management systems also provide dynamic system views. The dynamic system view provides information on current user sessions and resource utilization. For example, one popular database management system provides several dynamic performance views which are security relevant, V_$SESSION lists information for each current user session, V_$SESS_IO lists I/O statistics for each user session, V_$SESSTAT lists user session statistics, V_$ACCESS shows objects that are currently locked and the sessions that are accessing them and V_$SQL shows the SQL command text in the SQL pool.

As compared to an audit trail, which is typically a permanent record, database dynamic views typically comprise transient data. Database dynamic views can be monitored by taking periodic samplings of the database. It is possible that approaches using the periodic sampling will fail to detect certain suspicious database access that occurs between the monitoring intervals. To minimize this possibility, the sampling interval may be set to be quite short. Auditing approaches, in contrast, provide for all audited events to appear in the audit trail until purged. Also, dynamic views provide general information about database accesses at a relatively coarser granularity, while an audit trail provides relatively more detailed and specific information on database object level of granularity. In one embodiment, dynamic views can be used as supplementary information or as an alternate source of information when the audit trail is not available, such as when the database audit facility is not active.

Database triggers are another technique for gathering information from the database being monitored, which can be useful in applications where real time monitoring is not considered to be too intrusive by users of the database. Database transaction redo logs are a yet further technique for gathering information on data changes that can be useful in applications where information about read-only accesses is not needed.

FIG. 3B is a flow diagram that illustrates a high level overview of data collection processing in one embodiment. In block 311, the type of information to be monitored is received. In block 312, a monitoring level is determined based upon the type of information to be monitored. In block 313 audit options of the database manager are activated based upon the monitoring level. In block 314, a data set is read from the audit trail. In block 315, the data set is processed. In block 316, a test is performed to determine whether there is any more data to be read. If there is more data to read, then control continues back with block 314. Otherwise the control returns to the caller.

The data collector collects user behavior data from audit trail or dynamic performance views, processes the information, and stores the data as historical data. The historical data can be saved in an internal database for example. In one embodiment, a variety of attributes are recorded in the historical data for each action of interest. For example, a SELECT or a LOGIN action will include attributes such as, without limitation: (1) an operating system user identifier (OSUSER); (2) a database user identifier of the user who performs the action (DBUSER); (3) a subject schema object identifier (OBJECT); (4) owner of the object (OWNER); (5) a client system identifier (LOCATION); (6) an action identifier (ACTION); (7) a time of action (TIMESTAMP); (8) number of logical reads for the session (READ); (9) number of logical writes for the session (WRITE); and (10) a success or failure reason code (RETURNCODE).

Database user behavior monitoring can be performed from different perspectives each having a different focus, including, for example, database object level, database user level, and database session level.

For example, in one embodiment, database object level monitoring includes monitoring database accesses for a selected critical or sensitive database object. A database object can be a database table, database view, or database stored procedure. Database monitoring will track who, when, where and how often this object is accessed by any user. An example of a critical database object is a company's “employee” table, which contains salary information of the employees.

In another example, in one embodiment, database user level monitoring includes monitoring database object accesses by a selected database user. Database monitoring will track what, when, where and how often this user accesses any object. An example of a selected database user may be a disgruntled employee who is suspected of stealing information from the database.

In a further example, in one embodiment, database session level monitoring includes monitoring a database connection or a login session by a selected database user. Database monitoring will track login duration, login failure and resource utilization by this user.

In one embodiment, one or more different audit options in the database are automatically enabled based on a level of monitoring to be performed by the database audit engine. The audit option enabled is dependent upon the database management system of the subject database. For example, in one embodiment, to support database object level monitoring, the database monitoring system automatically enables object auditing for a specific object. To support database user level or session level monitoring, the system automatically enables statement auditing for a specific user.

Data Analysis

Embodiments of the present invention may implement one or more approaches to intrusion detection data analysis. In one embodiment, statistics-based intrusion detection (SBID) and rule-based intrusion detection (RBID) maybe used in conjunction to detect anomalous database accesses. In embodiments using statistics-based intrusion detection, a statistical analysis of a history of user behavior information is performed in order to generate user behavior patterns. Any subsequent database accesses that deviate significantly from these patterns will be determined to represent anomalous activity. Embodiments using rule-based intrusion detection maintain a knowledgebase comprised of security rules or constraints, also known as policies. A database access that violates a policy may be determined to represent anomalous activity.

FIG. 3C is a flow diagram that illustrates a high level overview of data analysis processing implementing statistical based intrusion detection in one embodiment. In block 331, a frequency of database access is determined from the historical data. Based on the historical data, a statistical model may be built and validated for use in detecting anomalous activity. The statistical analysis of historical data can determine normal database access rates.

In block 332, a probability function for frequency of database access is determined from the frequency of database access determined in block 331. The frequency of database access can be fit into a probability distribution. In specific embodiments, various probability distributions may be used, such as without limitation, a Normal probability distribution or Poisson probability distribution.

In one example, users access the database at a fixed rate randomly during the day or during the night. The rates of database access may vary for daytime and nighttime. Under this set of criteria, a Poisson distribution may be used to describe the database access frequencies in which the time between events follows an exponential distribution. Letting X represent the number of random occurrences per interval, m the average number of random occurrences per interval and P the probability of X having n occurrences in the interval is:

$$P ( X = n ) = {ⅇ}^{- m} [ \frac{{m}^{n}}{n !} ] \qquad ( 1 )$$

In block 333, the Cumulative Distribution Function (CDF) can be determined. In an embodiment using a Poisson Distribution, the Cumulate Distribution Function gives the probability of X having a value less than or equal to n as shown by equation (2):

$$F ( n ) = P ( X \text{<=} n ) = {\sum }_{i = 0}^{n} {ⅇ}^{- m} [ \frac{{m}^{i}}{i !} ] \qquad ( 2 )$$

The data analyzer determines the parameter value of the probability distribution function. In the case of Poisson distribution, it is the value of m, the average number of random occurrences per interval for the historical data.

For example, an occurrence may be defined as the number of SELECT commands issued against the database and the interval may be defined as an hour in a day. In other implementations, an occurrence may be defined as other types of commands or events and intervals may be defined as other time periods. In subsequent processing, the anomaly detector compares new data points against historical data based on the probability function.

In various embodiments, the data analyzer analyzes the historical data based on multiple dimensions of attributes, including without limitation, OS user, database user, location, and object. The access frequency can be calculated for each OS user, database user, location, object or a combination of multiple attributes. Measurements based on various dimensions may be used for quantitative comparison.

For example, in one embodiment, object level monitoring may include, without limitation, one or more of the following measurements: object access frequency by hour of day, object access frequency by hour of day and OS user, object access frequency by hour of day and database user, object access frequency by hour of day and location, and a multiple-dimension object access frequency rule that includes object access frequency by hour of day and combination of attributes (OS user, database user, and location).

In another example, in one embodiment, user level monitoring may include, without limitation, one or more of the following measurements: user access frequency by hour of day, user access frequency by hour of day and OS user, user access frequency by hour of day and database user, user access frequency by hour of day and location, and a multiple-dimension object access frequency rule that includes user access frequency by hour of day and combination of attributes (OS user, database user, and location).

In addition to object or user access frequency, other measurements can be used for session level monitoring in various embodiments, such as without limitation, access frequency by session measured by a number of page reads per session, access duration by session measured by a number of hours per session, and access ratio measured by a number of page reads per minute.

Anomaly Detection

FIG. 3D is a flow diagram that illustrates a high level overview of anomaly detection processing in one embodiment. In block 351, a frequency of database access is determined from new set of data.

In block 352, a threshold frequency is determined from the guard criteria and the probability function parameter. In one embodiment, the probability function parameter is the access frequency of historic data, determined previously by the data analyzer in block 331. In one embodiment, the access frequency is the average number of SELECT operations by the hour of day.

For example, if the data analyzer determines that the average access frequency for 2 AM is 1.5 from the historical data, and new data is received that indicates a current access frequency for 2 AM is 7, is the new data outside of the norm? The answer depends on the guard criteria. In one embodiment, the guard criteria may be expressed as a probability percentile. The anomaly detector determines the threshold access frequency value from the guard criteria probability percentile and the probability function parameter, i.e., the historical access frequency that was computed by the data analyzer in block 331. Any frequency value exceeding the threshold value will fail the test and be considered as an anomaly. The lower the guarding percentile, the more difficult it is for events to be classified as anomalous, and the fewer false alarms will be raised.

For example, if the guard probability criteria is specified as 0.1%, the anomaly detector calculates the threshold value n such that the probability of having a value exceeding n is less than 0.1% as shown in equation (3):
P(X>n)=1−P(X<=n)<0.1% (3)

This is equivalent to determining the threshold value n such that the probability of having a value less or equal to n is more than 99.9% as shown in equation (4):
F(n)=P(X<=n)>99.9% (4)

Substituting the cumulative distribution function in equation (2) with F(n)>99.9% from equation (4), and m of value 1.5 (probability function parameter, the average access frequency of historic data), results in a threshold value for n of 6.

Since the access frequency of new data set is 7, which exceeds the threshold access frequency value 6, an anomaly will be detected.

In block 353, the value of the current access frequency (from block 351) is compared against the threshold access frequency (from block 352).

In one embodiment, the anomaly detector detects suspicious database access in the historical data based on either dynamic statistical patterns and/or static rule-based policies, and generates email alerts. Reports or graphs can also be generated.

Security policies can be used to monitor database user behavior. For example, in an embodiment, there are two different categories of security policies: (1) access frequency policies and (2) access violation policies. Access frequency policies enable the database audit engine to guard the number of accesses by hour of day based on various dimensions. Such intrusion detection can be statistic-based, as discussed previously, and/or rule-based. In an embodiment, guarding thresholds can be specified as an absolute value in terms of number of accesses by hour of day or the like. Access violation policies enable the database audit engine to guard each individual database access using explicit security rules. Table 1 illustrates the various security policies that can used to monitor database user behavior in one embodiment.

TABLE 1
Security Policies

| Monitoring | | | Intrusion Detection |
|---|---|---|---|
| Levels | Categories | Security Policies | Method |
| Object Level | Access | Object Access Frequency by hour of | Statistics-Based or |
| Monitoring | Frequency | day | Rule-Based |
| | | Object Access Frequency by hour of | Statistics-Based or |
| | | day and OS user | Rule-Based |
| | | Object Access Frequency by hour of | Statistics-Based or |
| | | day and Database user | Rule-Based |
| | | Object Access Frequency by hour of | Statistics-Based or |
| | | day and Location | Rule-Based |
| | | Multiple-dimension Object Access | Statistics-Based or |
| | | Frequency Rule | Rule-Based |
| | Access Violation | Object Access Security Violation | Rule-Based |
| | | Object Access by suspicious OS user | Rule-Based |
| | | Object Access by suspicious | Rule-Based |
| | | Database user | |
| | | Object Access from suspicious | Rule-Based |
| | | Location | |
| | | Multiple-dimension Object Access | Rule-Based |
| | | Violation Rule | |
| User Level | Access | User Access Frequency by hour of | Statistics-Based or |
| Monitoring | Frequency | day | Rule-Based |
| | | User Access Frequency by hour of | Statistics-Based or |
| | | day and OS user | Rule-Based |
| | | User Access Frequency by hour of | Statistics-Based or |
| | | day and Database object | Rule-Based |
| | | User Access Frequency by hour of | Statistics-Based or |
| | | day and Location | Rule-Based |
| | | Multiple-dimension User Access | Statistics-Based or |
| | | Frequency Rule | Rule-Based |
| | Access Violation | User Access Security Violation | Rule-Based |
| | | User Access by suspicious OS user | Rule-Based |
| | | User Access of suspicious Database | Rule-Based |
| | | object | |
| | | User Access from suspicious Location | Rule-Based |
| | | Multiple-dimension User Access | Rule-Based |
| | | Violation Rule | |
| Session Level | Access | High read ratio (page/min) | Statistics-Based or |
| Monitoring | Frequency | | Rule-Based |
| | | Excessive read activities | Statistics-Based or |
| | | | Rule-Based |
| | | Extremely long login session | Statistics-Based or |
| | | | Rule-Based |
| | Access Violation | Login Failure | Rule-Based |
| | | Login at suspicious time frame | Rule-Based |
| | | Login by suspicious OS user | Rule-Based |
| | | Login from suspicious Location | Rule-Based |
| | | Multiple-dimension Session Rule | Rule-Based |

For example, in various embodiments, the following access violation rules can be specified for object level monitoring: (1) object access security violation, in which any failed attempt to read specific object without proper permission is alerted; (2) object access by suspicious OS user, in which any successful read of specific object by invalid OS users is alerted. In one embodiment, a list of valid OS users can be defined, and any access by an OS user not in the list will be alerted. In another embodiment, a list of invalid OS users can be defined, and any access by an OS user in the list will be alerted; (3) object access by suspicious database user, in which any successful read of specific object by invalid database users is alerted. In one embodiment, a list of valid and/or invalid database users can be defined; (4) object access from suspicious location, in which any successful read of specific object from invalid client system is alerted. In one embodiment, a list of valid and/or invalid locations can be defined; and (5) multiple-dimension object access rule, in which any successful read of specific object with invalid combination of attributes (OS user, database user, and location) is alerted.

In another example, in various embodiments, the following access violation rules can be specified for user level monitoring: (1) user access security violation, in which any failed read attempt by specific database user without proper permission is alerted; (2) user access by suspicious OS user, in which any successful read by specific database user from invalid OS users is alerted. In one embodiment, a list of valid and/or invalid OS users can be defined; (3) user access of suspicious database object, in which any successful read by specific database user to invalid database objects is alerted. In one embodiment, a list of valid and/or invalid objects can be defined; (4) user access from suspicious location, in which any successful read by specific database user from invalid client systems is alerted. In one embodiment, a list of valid and/or invalid locations can be defined; and (5) multiple-dimension user access rule, in which any successful read by specific database user with invalid combination of attributes (OS user, database object, and location) is alerted.

In a further example, in various embodiments, the following access violation rules can be specified for session level monitoring, the following access violation rules can be specified: (1) login failure, in which failure to login due to invalid password is alerted; (2) login at suspicious time frame, in which time of login that is beyond specified normal hours is alerted; (3) login by suspicious OS user, in which any successful login by specific database user and invalid OS user is alerted. In one embodiment, a list of valid and/or invalid OS users can be defined; (4) login from suspicious location, in which any successful login by specific database user from invalid client systems is alerted. In one embodiment, a list of valid and/or invalid locations can be defined; and (5) multiple-dimension session rule, in which any successful login with invalid combination of attributes (OS user and location) is alerted.

Monitoring Example

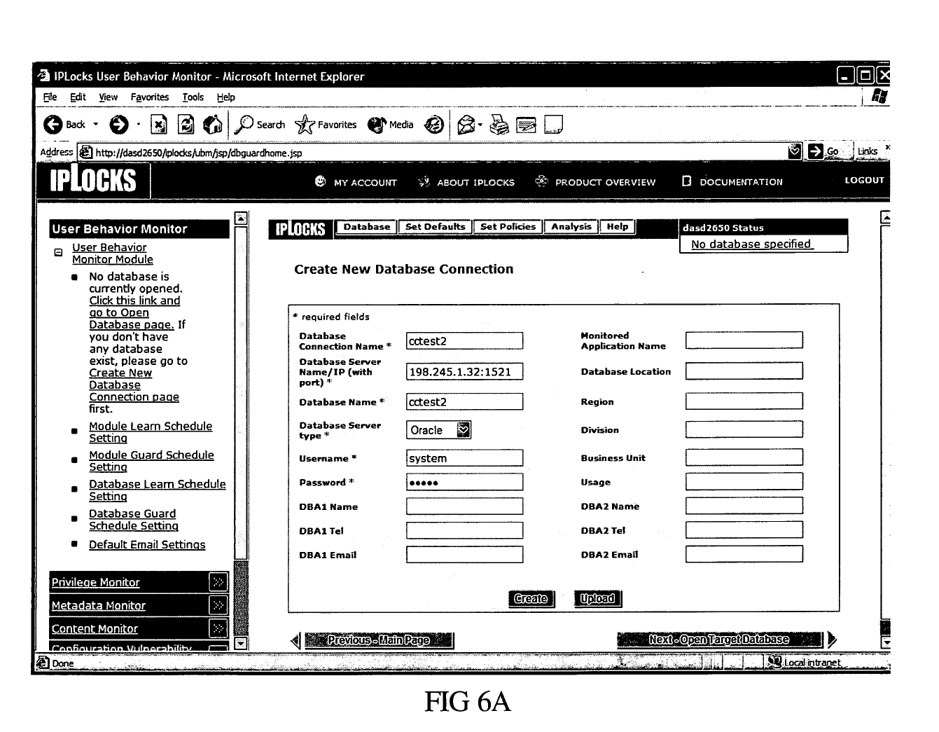

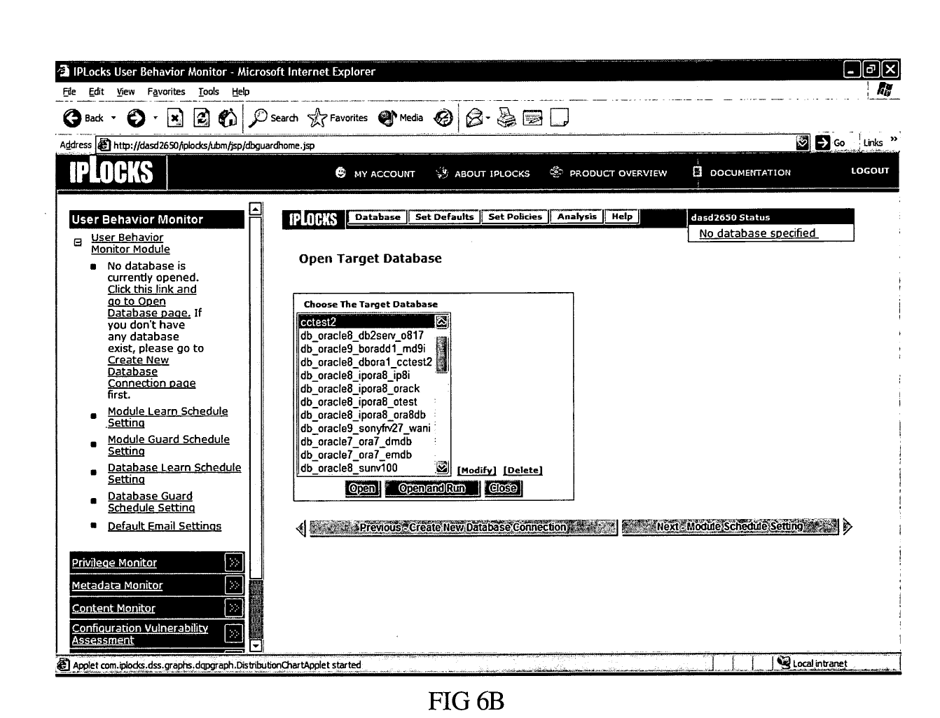

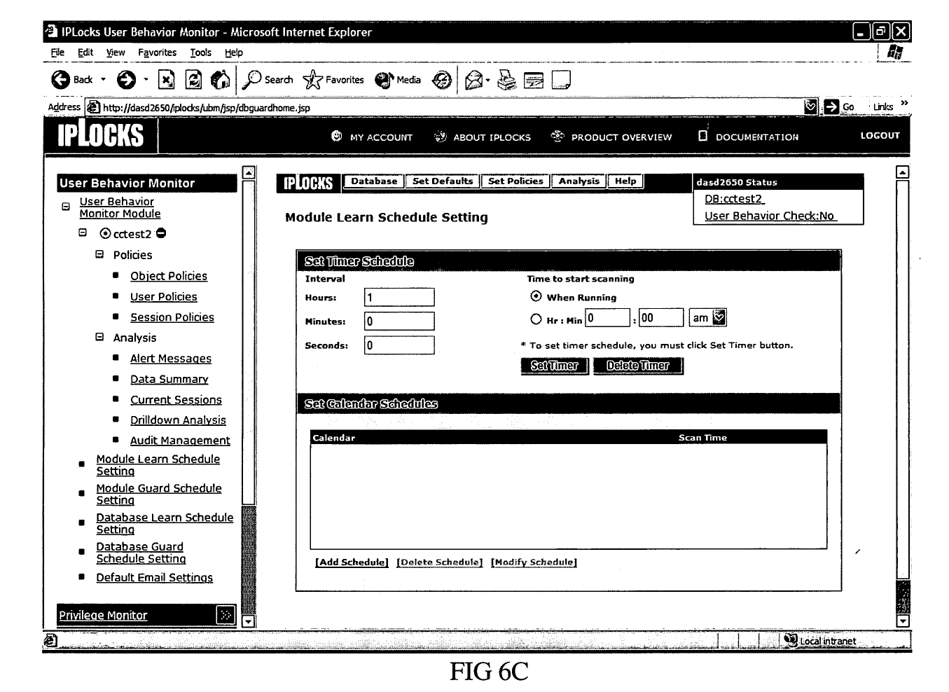

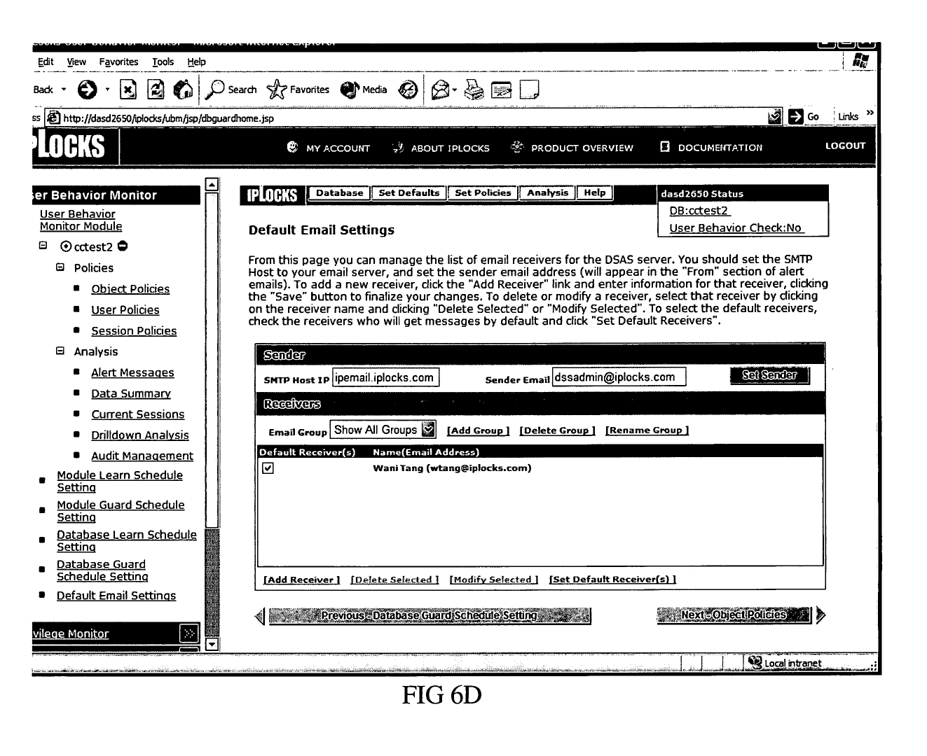

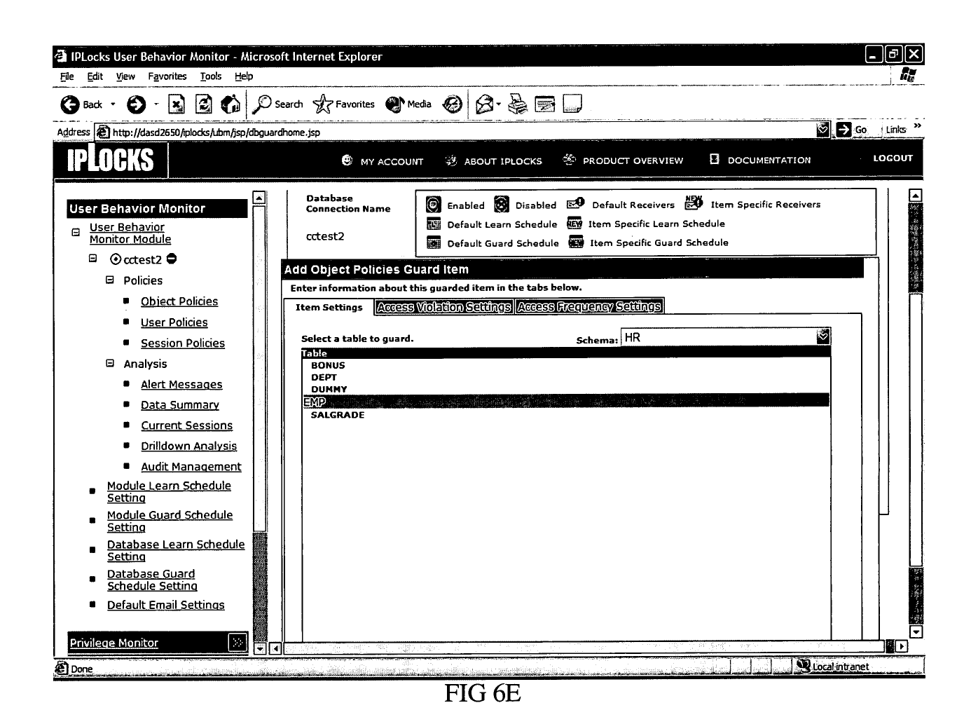

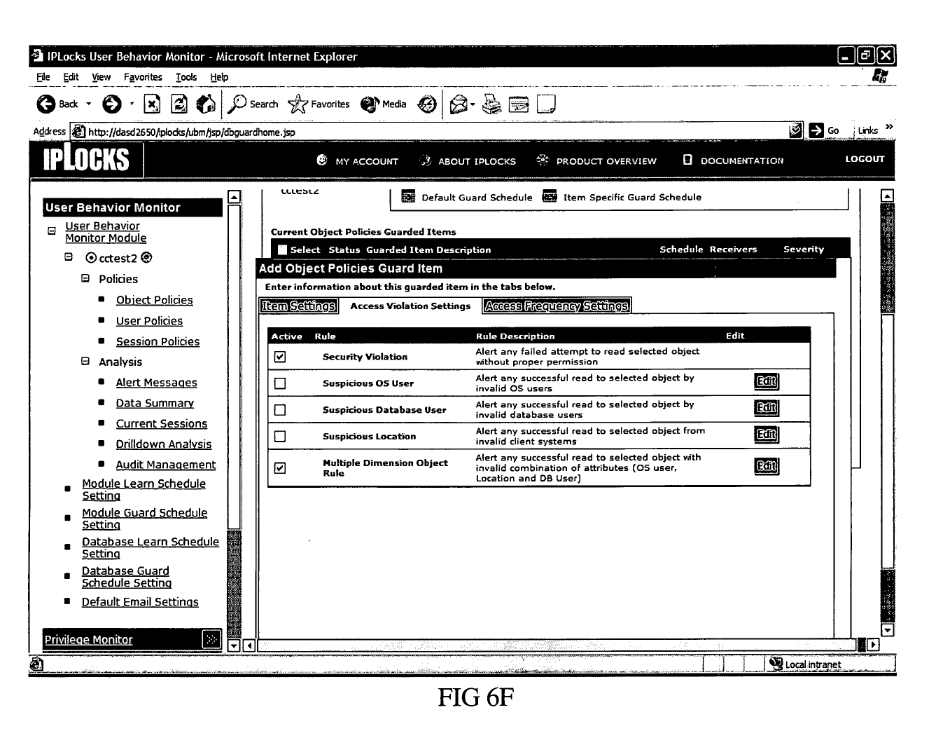

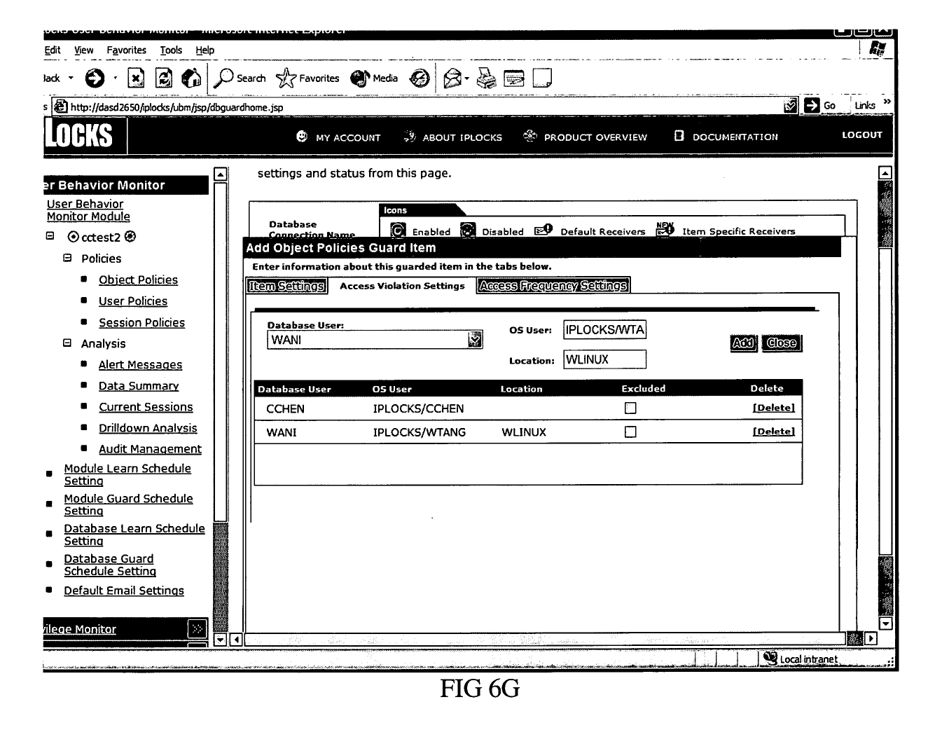

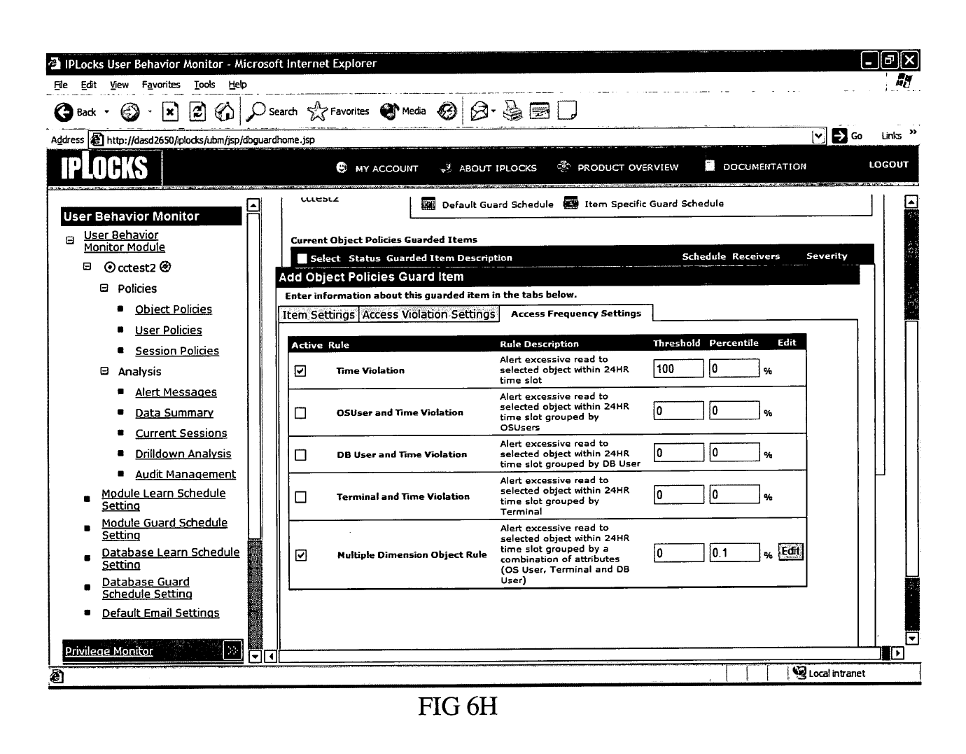

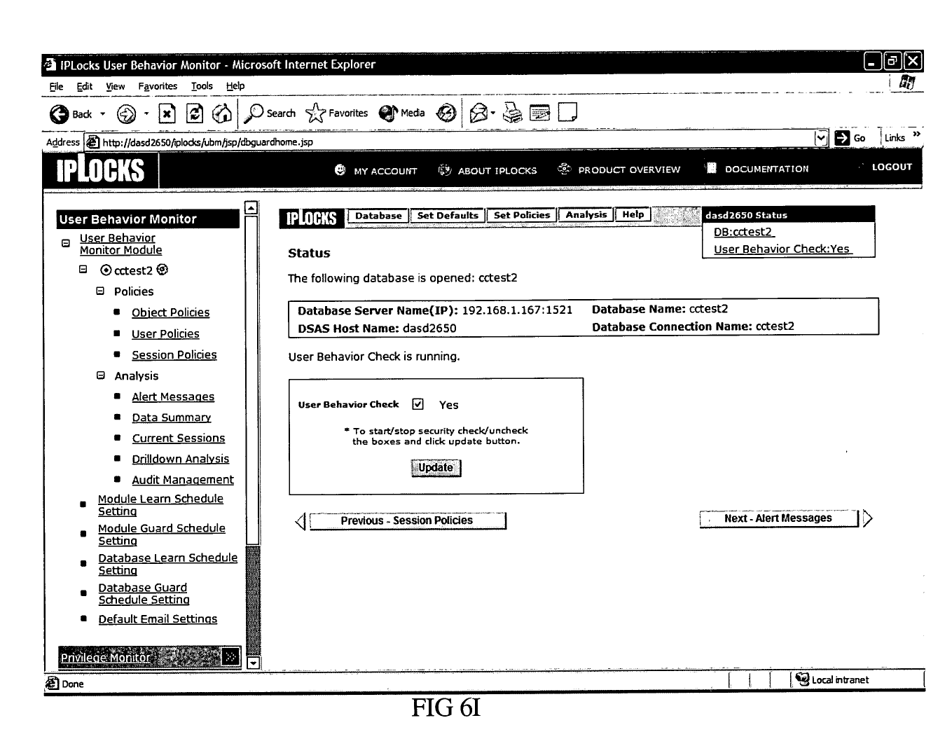

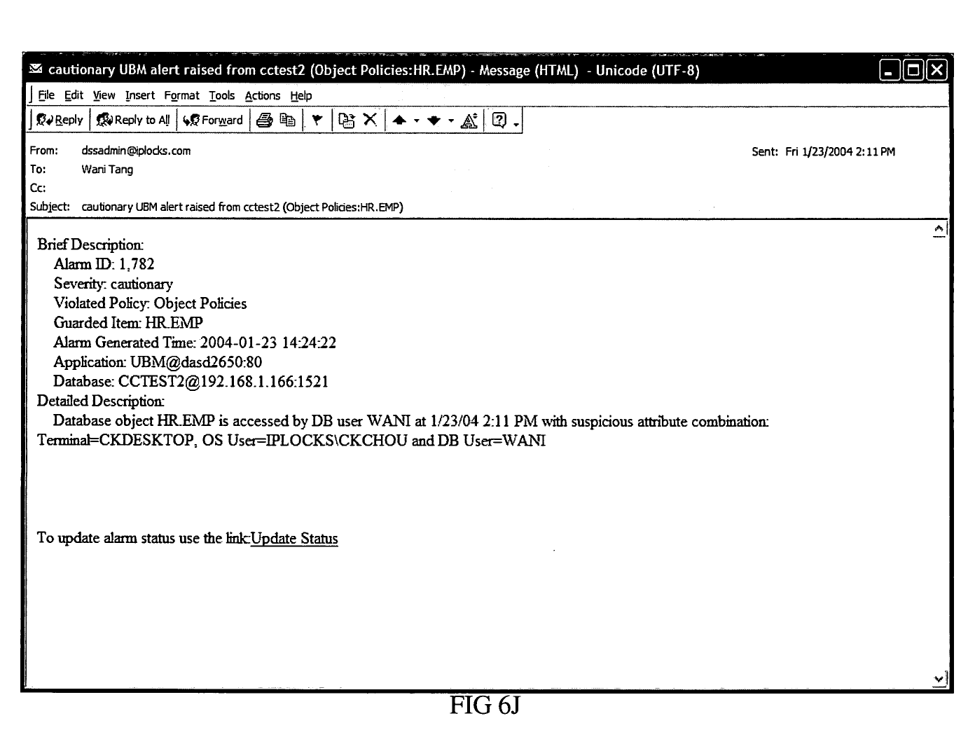

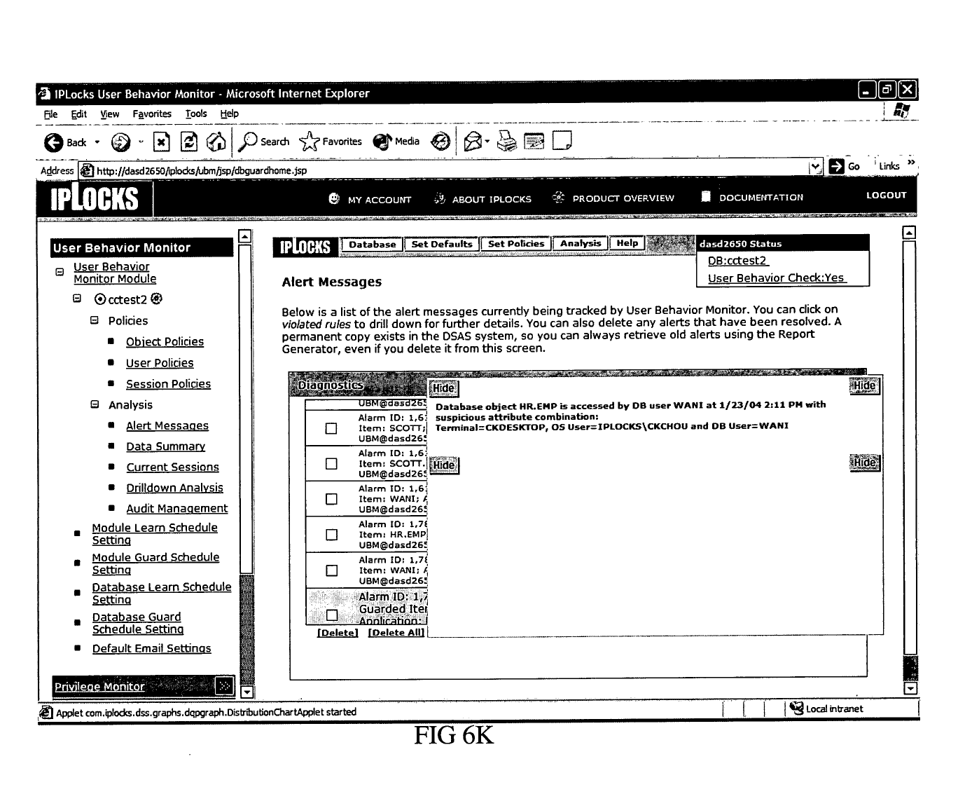

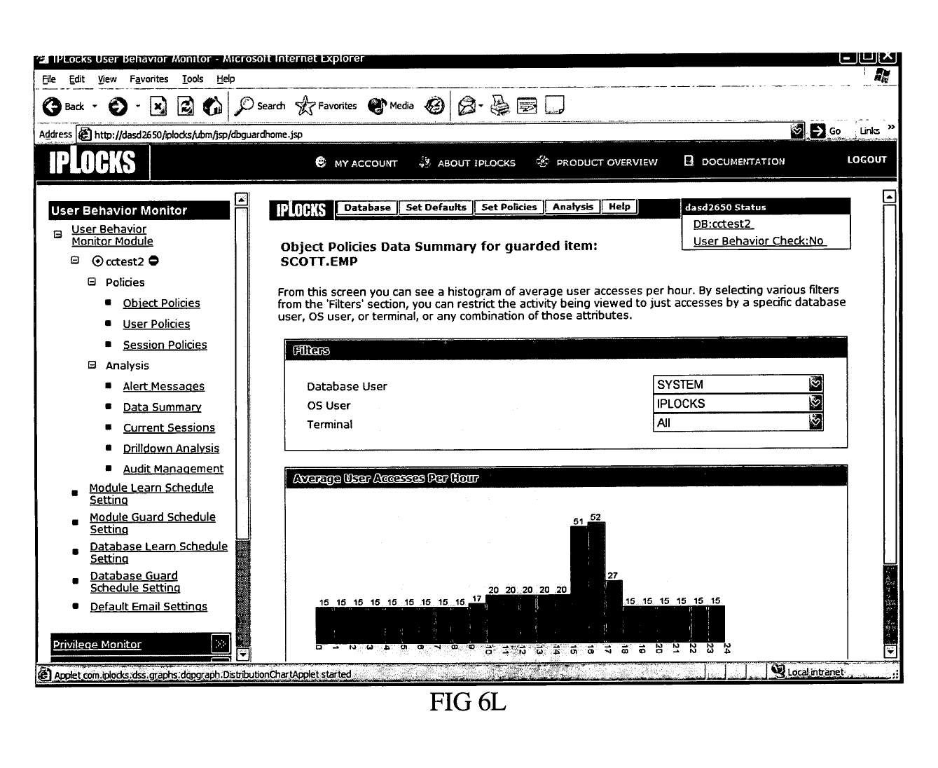

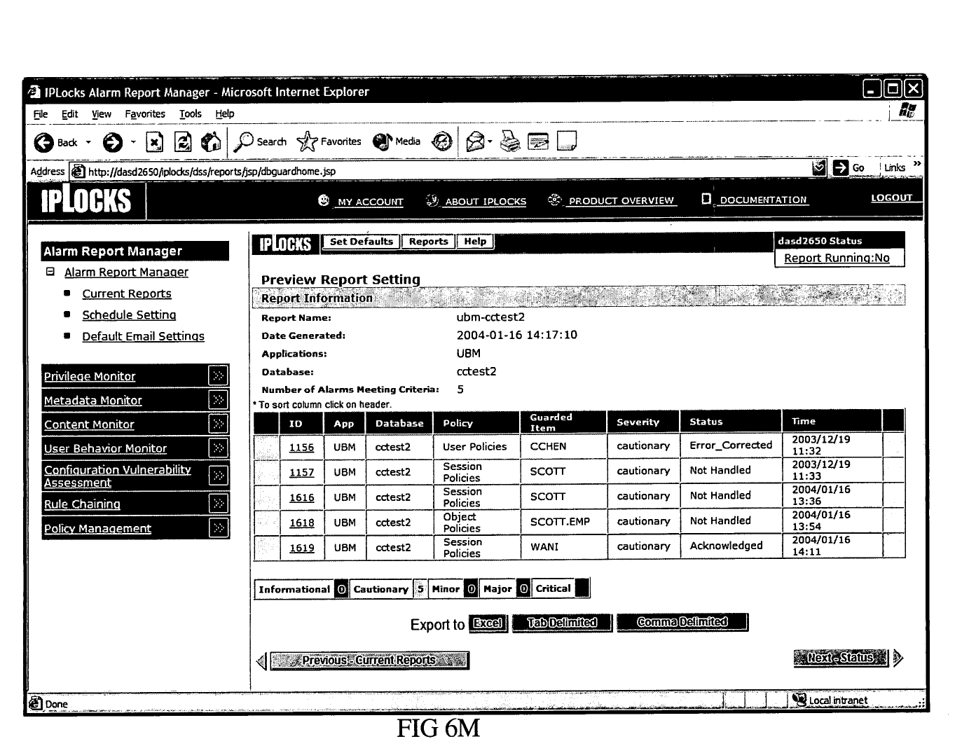

The operation of database monitoring in one embodiment will be illustrated using an example of configuring and using monitoring operations for a database discussed with reference to flow diagram FIG. 3E and screen shots illustrated by FIGS. 6A-6M. In one embodiment, configuring a monitoring operation is performed with a graphical user interface implemented using a web browser. In the example user interface screens depicted by FIGS. 6A-6M, users can follow the previous/next navigation arrows to step through the process of configuring a monitoring operation. Alternatively, users may select an item from the menu bar on the top panel, or click a link from the hierarchical tree view on the left panel.

The user may begin the process by opening the database to be monitored, as indicated by FIG. 3E, block 410. In an embodiment, opening the database includes defining a database connection by specifying the host name, database name, user name and password, as shown in FIG. 6A. The user connects to the specified database, as shown in FIG. 6B.

In block 420, the user configures a monitoring schedule for the specified database. During the process of configuring the monitoring schedule includes, the user specifies how often the data analyzer is to ‘learn’ the user behavior data and reconstruct the statistical model, as shown in FIG. 6C. The user also specifies how often the anomaly detector is to ‘guard’ against anomalous data, and send out the alerts, again using the screen depicted in FIG. 6C.

In block 430, the user configures e-mail receivers. The user specifies whom to send the alert emails when anomaly occurs using the screen depicted in FIG. 6D in one example embodiment.

In block 440, the user configures monitoring policies. Screens depicted by FIGS. 6E-6F illustrate configuration of monitoring policies in an example embodiment. The user selects a ‘critical’ object to monitor, as shown in FIG. 6E. The user selects the access violation policies to activate for this object, as shown in FIG. 6F. The user specifies who will be allowed to access this object. For multiple dimension object rules, it can be defined as a combination of attributes. For example, database user WANI can access this object only when she is logged in as OS user IPLOCKS/WTANG and from client system WLINUX, as shown in FIG. 6G. The user also specifies the access frequency policies to activate in order to monitor this object, as shown in FIG. 6H.

In block 450, the user starts monitoring. In one embodiment, monitoring is started by clicking a check box in a status screen as depicted by FIG. 61.

In block 460, user views alerts and/or graphs. In a hypothetical example, a database password belonging to a database user WANI is stolen, and the wrongdoer attempts to access a database object using the stolen password from a machine other than the one the password was assigned for use. The wrongdoer's attempted use would cause an access violation of a multiple dimension object rule, such as depicted by FIG. 6J. For example, the configured multiple dimension object rule indicates that database user WANI can only access the object HR.EMP by OS user IPLOCKS/WANI, and from location WLINUX (as shown in FIG. 6G). The wrongdoer attempts to access the object as database user WANI by different OS user IPLOCKS/CKCHOU and from different location CKDESKTOP, which causes an access violation. A targeted operation may be triggered. In the example illustrated by FIG. 6J, an email alert will be sent to the email receivers defined using the screen depicted by FIG. 6D. The user views alerts through the graphic user interface, as shown in FIG. 6K. The user also views the access pattern for any object by any user, as shown in FIG. 6L. If the user violates the access frequency threshold or percentile, an alert will also be sent.

In block 470, a user generates reports. The user generates summary reports on the alerts, which can help analyze the problems, as shown in FIG. 6M. The process described above with reference to FIG. 3E and FIGS. 6A-6M is merely one example using one embodiment. Other embodiments will include other processes and screens not discussed here for brevity, and/or may omit some of the processing and/or screens described.

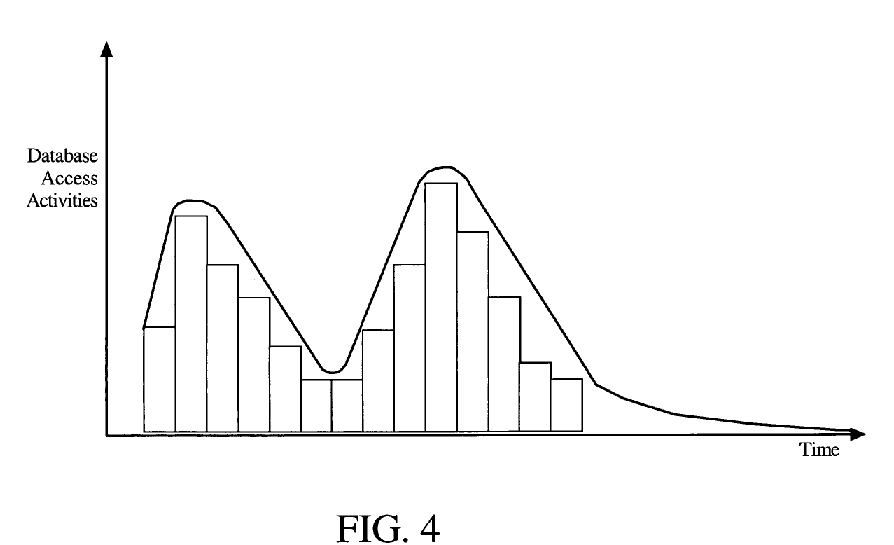

FIG. 4 is a graph that illustrates an example probability distribution of accesses to a database in one embodiment. FIG. 4 depicts an example of database access activities by a particular user during a 24-hour period. In FIG. 4, each bar represents the number of object accesses per hour by this user. In the example probability distribution depicted by FIG. 4, the probability that users will access the database has two peaks, one peak likely to occur in the mid morning hours and another peak likely to occur in the mid afternoon hours. Excessive database access activity outside of these time frames would likely be suspect.

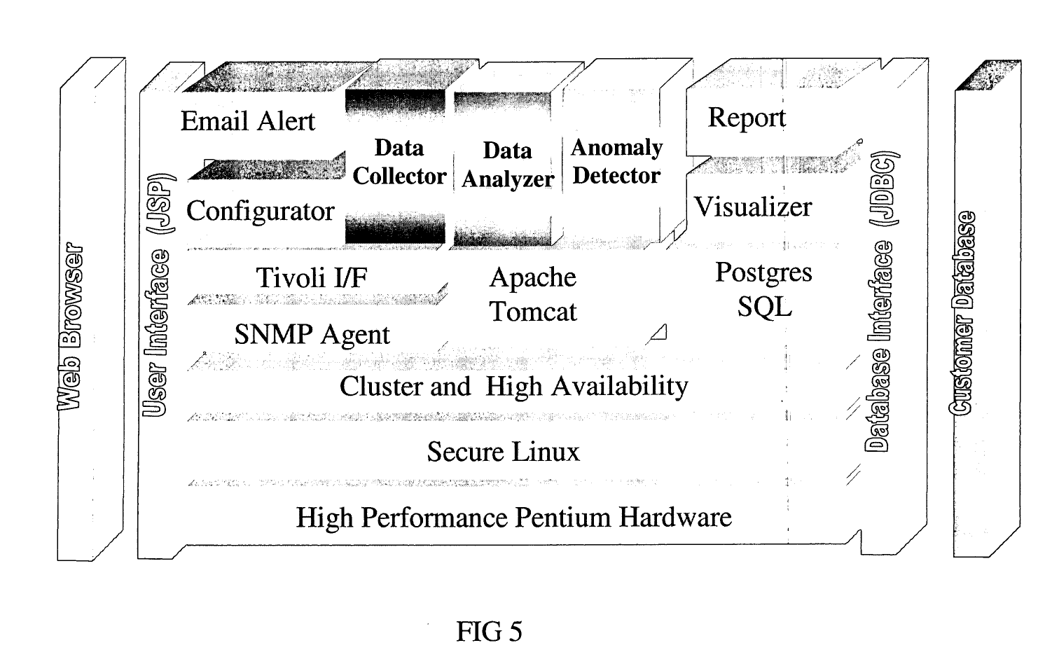

FIG. 5 is a block diagram that illustrates a high level overview of a database monitoring system in one embodiment. As depicted by FIG. 5, a database monitoring system comprises a three-tier architecture. In a first tier, the database monitoring system includes a web browser for providing access to the database monitoring functionality. In one embodiment, Java Sever Pages (JSP) provides a user interface.

In a second tier, the database monitoring system uses a web server, which in one embodiment is implemented using Apache Tomcat, and an internal database for storing of history data, which in one embodiment is implemented using a PostgreSQL™ database. Embodiments of the present invention can reside on any computing platform, such as without limitation a Pentium™ or equivalent functionality hardware platform executing in conjunction with a secure Linux operating system. Components of the database monitoring system include the data collector, data analyzer and anomaly detector. Supporting components include one or more of the following: (1) a configurator that enables the user to customize the database monitoring system according to implementation specific needs, such as scheduling setting and policy setting; (2) an Email alert that sends alert messages to designated security officers; (3) a report manager generates diagnosis reports; and (4) a visualizer that generates graphical representation of database user behavior patterns.

In a third tier, the database monitoring system uses a Java Database Connectivity (JDBC) API to access the target database.

Hardware Overview

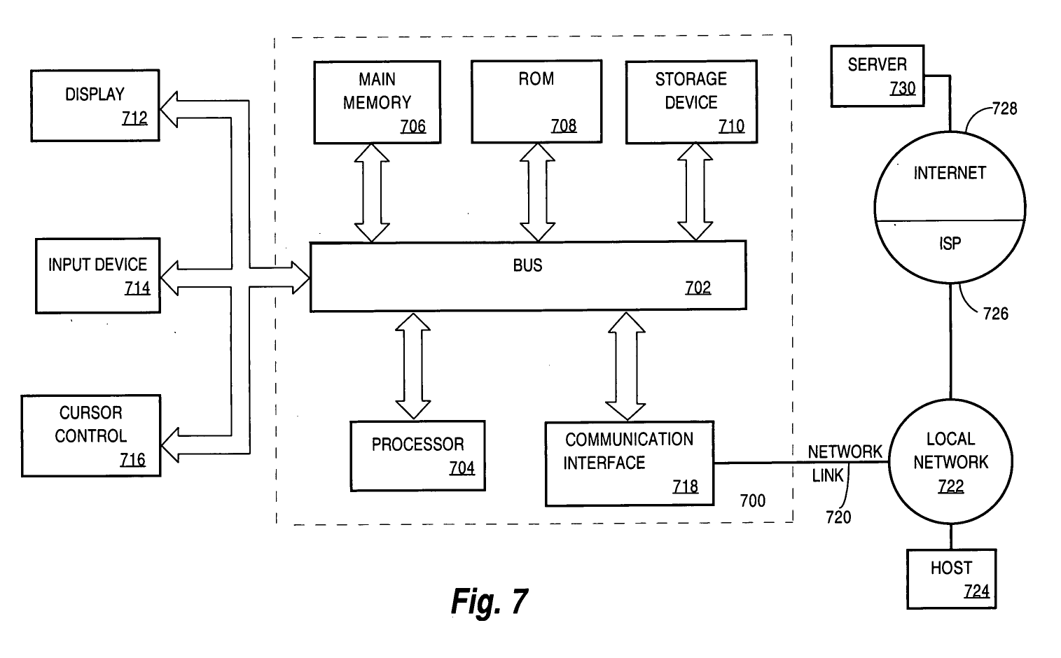

In one embodiment, the various components of computing environment 100 shown in FIG. 1 can be implemented as sets of instructions executable by one or more processors. FIG. 7 shows a hardware block diagram of a computer system 700 which may be used to execute these components. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

According to one embodiment, the functionality of the present invention is provided by computer system 700 in response to processor 704 executing one or more sequences of one or more instructions contained in main memory 706. Such instructions may be read into main memory 706 from another computer-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage device 710, or other non-volatile storage for later execution. In this manner, computer system 700 may obtain application code in the form of a carrier wave.

In the foregoing specification, it should be noted that although the invention has been described with reference to a specific embodiment, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims. The specification and drawings are, accordingly, to be regarded as illustrative rather than limiting.

1. A method for monitoring a database, comprising:
collecting user behavior data that indicates how one or more users use the database;
processing and storing the data as historical data;
analyzing the historical data to determine behavior patterns;
receiving a new set of data that indicates how one or more users have used the database;
performing a comparison between the new set of data and the behavior pattern;
determining based on the comparison, whether the new set of data satisfies a set of criteria;
if the new set of data satisfies the set of criteria, then determining that the new set of data represents anomalous activity; and
responding to the determination by performing a targeted operation.

2. The method of claim 1, further comprising:
determining if the new set of data violates a rule based policy; and
if the new set of data violates the rule based policy, then determining that the new set of data represents anomalous activity.

3. The method of claim 2, wherein collecting user behavior data further comprises:
reading information from an audit trail or dynamic performance views of the database manager.

4. The method of claim 3, wherein collecting user behavior data further comprises collecting information at a monitoring level selected from at least one of:
information about database access for one or more selected database objects;
information about database access for one or more selected database users; and
information about database access for one or more selected database user sessions.

5. The method of claim 3, wherein collecting user behavior data further comprises:
receiving a type of information to be monitored;
determining a monitoring level from the type of information; and
activating audit options of the database manager based upon the monitoring level determined.

6. The method of claim 2, wherein analyzing the historical data to determine behavior patterns further comprises:
determining a statistical model from the historical data.

7. The method of claim 6, wherein determining a statistical model from the historical data further comprises:
determining a frequency of database access from the historical data;
determining a probability function for frequencies of database access; and
determining a cumulative probability function from the probability function.

8. The method of claim 7, wherein performing a comparison between the new set of data and the behavior pattern further comprises:
testing a hypothesis using the new set of data against the statistical model.

9. The method of claim 8, wherein testing a hypothesis using the new set of data against the statistical model further comprises:
determining a frequency of database access for the new set of data; and
determining the threshold value from a guard criteria and a probability function parameter.

10. The method of claim 9, wherein testing a hypothesis using the new set of data against the statistical model pattern further comprises:
comparing the frequency of database access for the new set of data with the threshold value.

11. The method of claim 7, wherein the historical information is about database access for one or more selected database objects and wherein determining a frequency of database access from the historical data further comprises determining a frequency of at least one of:
object access frequency by hour of day, object access frequency by hour of day and operating system user, object access frequency by hour of day and database user, object access frequency by hour of day and location, object access frequency by hour of day and combination of at least two of operating system user, database user and location.

12. The method of claim 7, wherein the historical information is about database access for one or more selected database users and wherein determining a frequency of database access from the historical data further comprises determining a frequency of at least one of:
user access frequency by hour of day, user access frequency by hour of day and operating system user, user access frequency by hour of day and database user, user access frequency by hour of day and location, user access frequency by hour of day and a combination of at least two of operating system user, database user, and location.

13. The method of claim 7, wherein the historical information is about database access for one or more selected database user sessions and wherein determining a frequency of database access from the historical data further comprises determining a frequency of at least one of:
number of page reads per session, access duration per session, number of page reads per unit time.

14. The method of claim 1, wherein performing a targeted operation comprises at least one of: raising an alert; sending an email; producing a report; performing a visualization.

15. A computer-readable medium carrying one or more sequences of instructions for reverting to a recovery configuration in response to device faults, which instructions, when executed by one or more processors, cause the one or more processors to carry out the steps of:
collecting user behavior data that indicates how one or more users use the database;
processing and storing the data as historical data;
analyzing the historical data to determine behavior patterns;
receiving a new set of data that indicates how one or more users have used the database;
performing a comparison between the new set of data and the behavior pattern;
determining based on the comparison, whether the new set of data satisfies a set of criteria;
if the new set of data satisfies the set of criteria, then determining that the new set of data represents anomalous activity; and
responding to the determination by performing a targeted operation.

16. The computer-readable medium of claim 15, further comprising instructions which, when executed by the one or more processors, cause the one or more processors to carry out the steps of:
determining if the new set of data violates a rule based policy; and
if the new set of data violates the rule based policy, then determining that the new set of data represents anomalous activity.

17. The computer-readable medium of claim 16, wherein the instructions for carrying out the step of collecting user behavior data further comprise instructions for carrying out the step of:
reading information from an audit trail of the database manager.

18. The computer-readable medium of claim 17, wherein the instructions for carrying out the step of collecting user behavior data further comprise instructions for carrying out the step of collecting information at a monitoring level selected from at least one of:
information about database access for one or more selected database objects;
information about database access for one or more selected database users; and
information about database access for one or more selected database user sessions.

19. The computer-readable medium of claim 17, wherein the instructions for carrying out the step of collecting user behavior data further comprise instructions for carrying out the steps of:
receiving a type of information to be monitored;
determining a monitoring level from the type of information; and
activating audit options of the database manager based upon the monitoring level determined.

20. The computer-readable medium of claim 16, wherein the instructions for carrying out the step of analyzing the historical data to determine behavior patterns further comprise instructions for carrying out the step of:
determining a statistical model from the historical data.

21. The computer-readable medium of claim 20, wherein the instructions for carrying out the step of determining a statistical model from the historical data further comprise instructions for carrying out the step of:
determining a frequency of database access from the historical data;
determining a probability function for frequencies of database access; and
determining a cumulative probability function from the probability function.

22. The computer-readable medium of claim 21, wherein the instructions for carrying out the step of performing a comparison between the new set of data and the behavior pattern further comprise instructions for carrying out the step of:
testing a hypothesis using the new set of data against the statistical model.

23. The computer-readable medium of claim 22, wherein the instructions for carrying out the step of testing a hypothesis using the new set of data against the statistical model further comprise instructions for carrying out the steps of:
determining a frequency of database access for the new set of data; and
determining the threshold value from a guard criteria and a probability function parameter.

24. The computer-readable medium of claim 23, wherein the instructions for carrying out the step of testing a hypothesis using the new set of data against the statistical model further comprise instructions for carrying out the step of:
comparing the frequency of database access for the new set of data with the threshold value.

25. The computer-readable medium of claim 21, wherein the historical information is about database access for one or more selected database objects and wherein the instructions for carrying out the step of determining a frequency of database access from the historical data further comprise instructions for carrying out the step of determining a frequency of at least one of:
object access frequency by hour of day, object access frequency by hour of day and operating system user, object access frequency by hour of day and database user, object access frequency by hour of day and location and object access frequency by hour of day and a combination of at least two of operating system user, database user and location.

26. The computer readable medium of claim 21, wherein the historical information is about database access for one or more selected database users and wherein the instructions for carrying out the step of determining a frequency of database access from the historical data further comprise instructions for carrying out the step of determining a frequency of at least one of:
user access frequency by hour of day, user access frequency by hour of day and operating system user, user access frequency by hour of day and database user, user access frequency by hour of day and location and user access frequency by hour of day and a combination of at least two of operating system user, database user, and location.

27. The computer readable medium of claim 21, wherein the historical information is about database access for one or more selected database user sessions and wherein the instructions for carrying out the step of determining a frequency of database access from the historical data further comprise instructions for carrying out the step of determining a frequency of at least one of:
number of page reads per session, access duration per session, number of page reads per unit time.

28. The computer readable medium of claim 15, wherein the instructions for carrying out the step of performing a targeted operation comprises comprise instructions for carrying out at least one of: raising an alert; sending an email; producing a report;
performing a visualization.

29. An apparatus, comprising:
means for collecting user behavior data that indicates how one or more users use the database;
means for processing and storing the data as historical data;
means for analyzing the historical data to determine behavior patterns;
means for receiving a new set of data that indicates how one or more users have used the database;
means for performing a comparison between the new set of data and the behavior pattern;
means for determining based on the comparison, whether the new set of data satisfies a set of criteria;
means for determining that the new set of data represents anomalous activity, if the new set of data satisfies the set of criteria; and
means for responding to the determination by performing a targeted operation.

30. An apparatus, comprising:
a data collector for collecting user behavior data that indicates how one or more users use the database and processing and storing the data as historical data; and receiving a new set of data that indicates how one or more users have used the database;
a data analyzer for analyzing the historical data to determine behavior patterns; and an anomaly detector for performing a comparison between the new set of data and the behavior pattern; determining based on the comparison, whether the new set of data satisfies a set of criteria; determining that the new set of data represents anomalous activity if the new set of data satisfies the set of criteria; and responding to the determination by performing a targeted operation.
